(19) United States
(12) Patent Application Publication
(10) Pub. No.: US 2020/0410539 A1
(43) Pub. Date: Dec. 31, 2020

(54) System for Providing Personalized Marketing at a Mobile Device When in Proximity to a Retail Location

(71) Applicant: Dell Products L.P., Round Rock, TX (US)

(72) Inventors: James S. Watt, Jr., Austin, TX (US); Frank DiRosa, Pflugerville, TX (US)

(73) Assignee: Dell Products L.P., Round Rock, TX (US)

(21) Appl. No.: 16/456,595

(22) Filed: Jun. 28, 2019

(51) Int. Cl. G06Q 30/02

(52) U.S. Cl. CPC G06Q 30/0261; G06Q 30/0271; G06Q 30/0207; G06Q 30/0259

(57) ABSTRACT

A method, system and computer-usable medium are disclosed for providing personalized marketing at a mobile device when in proximity to a retail location. One general aspect includes a computer-implemented method for personalized proximity marketing including: detecting whether a mobile device is proximate a retail location of a product retailer; if the mobile device is proximate a retail location of the product retailer, querying a user profile associated with a user of the mobile device to determine whether the retail location has one or more items of interest available to the user of the mobile device, where the one or more items of interest are identified based on product preferences associated with the user profile; and in response to the query, alerting a user at the mobile device one or more of the items of interest are available at the retail location.

### BACKGROUND OF THE INVENTION

### Field of the Invention

The present invention relates to interoperation of information handling systems. More specifically, embodiments of the invention relate to a system for proximity marketing in which multiple information handling systems cooperate to provide personalized marketing at a mobile device when the mobile device is in proximity to a retail location.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Manufactures, retailers, OEMs, etc., employ information processing systems in various configurations to execute operations needed to manufacture, distribute, sell, etc., their products. As an example, a manufacturer or OEM may employ information processing systems that are configured to maintain inventory, schedule production, oversee product distribution, etc. As a further example, a retailer may employ information processing systems that are configured to maintain inventory and track sales of goods.

### SUMMARY OF THE INVENTION

A system of one or more computers can be configured to perform particular operations or actions by virtue of having software, firmware, hardware, or a combination of them installed on the system that in operation causes or cause the system to implement a system for providing personalized marketing at a mobile device when in proximity to a retail location. The system may be implemented by one or more computer programs can be configured to perform particular operations or actions by virtue of including instructions that, when executed by data processing apparatus, cause the apparatus to implement the system. One general aspect includes a computer-implemented method for personalized proximity marketing including: detecting whether a mobile device is proximate a retail location of a product retailer; if the mobile device is proximate a retail location of the product retailer, querying a user profile associated with a user of the mobile device to determine whether the retail location has one or more items of interest available to the user of the mobile device, where the one or more items of interest are identified based on product preferences associated with the user profile; and in response to the query, alerting a user at the mobile device one or more of the items of interest are available at the retail location.

Another general aspect includes a system including: a processor; a data bus coupled to the processor; and a non-transitory, computer-readable storage medium embodying computer program code, the non-transitory, computer-readable storage medium being coupled to the data bus, the computer program code interacting with a plurality of computer operations and including instructions executable by the processor and configured for: detecting whether a mobile device is proximate a retail location of a product retailer; if the mobile device is proximate a retail location of the product retailer, querying a user profile associated with a user of the mobile device to determine whether the retail location has one or more items of interest available to the user of the mobile device, where the one or more items of interest are identified based on product preferences associated with the user profile; and in response to the query, alerting a user at the mobile device that one or more of the items of interest are available at the retail location.

A further general aspect includes a non-transitory, computer-readable storage medium embodying computer program code, the computer program code including computer executable instructions configured for: detecting whether a mobile device is proximate a retail location of a product retailer; if the mobile device is proximate a retail location of the product retailer, querying a user profile associated with a user of the mobile device to determine whether the retail location has one or more items of interest available to the user of the mobile device, where the one or more items of interest are identified based on product preferences associated with the user profile; and in response to the query, alerting a user at the mobile device that one or more items of interest are available at the retail location.

Other embodiments of this aspect include corresponding computer systems, apparatus, and computer programs recorded on one or more computer storage devices, each configured to perform the actions of the methods.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that is configured as an escalation prediction system in accordance with certain embodiments;

FIG. 2 is a block diagram of an electronic environment in which certain embodiments of the escalation prediction system may be employed;

FIG. 3 is a flowchart depicting exemplary operations that may be executed by various components within the electronic environment shown in FIG. 2;

FIG. 4 is a diagram depicting the flow of communication and operations that may be executed in certain embodiments; and

FIG. 5 is a diagram depicting the flow of communication and operations that may be executed in certain embodiments.

### DETAILED DESCRIPTION

A system, method, and computer-readable medium are disclosed for provide personalized marketing at a mobile device when the mobile device is in proximity to a retailer. Certain aspects of the disclosure recognize that spamming consumers with too many notifications or irrelevant information is likely to distract them from identifying specific products that are of interest to the consumer. Certain aspects of the disclosure recognize that a user of a mobile device may be notified of the availability of items of interest based on their user profile when the mobile device is in proximity to a retailer, such as a registered retailer. As used herein, a “registered retailer” is a retailer having authorization from a product supplier to supply an item. Certain aspects of the disclosure also recognize that an alert may be sent to a mobile device regarding the availability of items of interest, discounts on the items of interest, or any other marketing information relating to the items of interest to the user when the mobile device is proximate the retailer.

Certain embodiments of the disclosed system may be implemented in one or more information handling systems used, for example, by a product supplier and/or product retailer. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

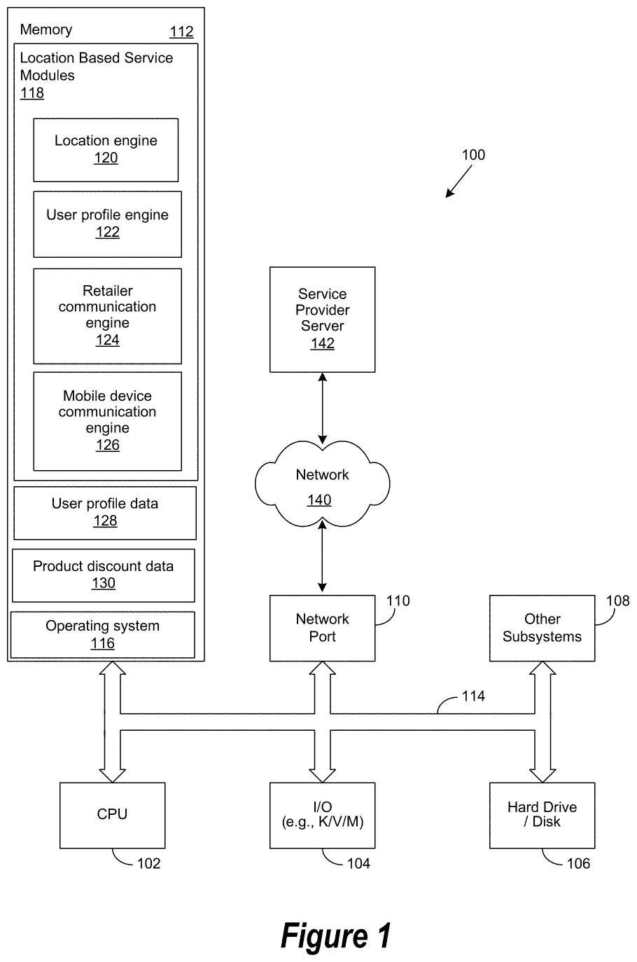

FIG. 1 is a generalized illustration of an information handling system that can be used to implement the system and method set forth in the present disclosure. In the example shown in FIG. 1, the information handling system is configured as a location-based service system 100 that is intended to receive location information from a mobile device when the mobile device is at a registered retailer, assess items that may be of interest to the user based on a user profile, and to cooperate with a product retailer system to assess the availability of items of interest and any discounts that may be available on such items. The location-based service system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the location-based discount service system 100 also includes network port 110 operable to connect to a network 140, which is likewise accessible by a service provider server 142 and registered retailers, as described herein. The location-based discount service system 100 likewise includes system memory 112, which is interconnected to the foregoing via one or more buses 114. System memory 112 further comprises operating system (OS) 116 and in various embodiments may also comprise location-based discount service modules 118.

In certain embodiments, the location-based service modules 118 include a location engine 120. In certain embodiments, the location engine 120 is configured to determine whether a mobile device is proximate a retail location of a product retailer. In certain embodiments, the mobile device prompts the location engine 120 to notify the location engine 120 that the mobile device is proximate a retail location the product retailer. Additionally, or on the alternative, a mobile device may transmit the location of the mobile device to the location engine 120, which may use the location data to determine whether the mobile device is proximate a retail location of the product retailer.

In certain embodiments, the location-based service modules 118 also includes a user profile engine 122. In certain embodiments, the mobile device sends user identification information to the user profile engine 122. In certain embodiments, the user profile engine 122 accesses user profile data 128 for the identified user and correlates the user profile data 128 with items that may be of interest to the identified user. In certain embodiments, the user profile data 128 may include any information associated with the user that may be utilized by the user profile engine 122 to identify products that may be of interest to the user. As an example, the user may have queried one or more websites of a product supplier/retailer in search of a specific product. The user's search for the product may be captured and stored in the user profile data 128. As an example, the user profile engine 122 may determine, based on the user profile data 128, that a user is interested in purchasing a laptop. As another example, the user profile engine 122 may determine that a user is interested in purchasing a specific brand of laptop having a particular configuration. It will be recognized, in view of the teachings of the present disclosure, that there are a variety of ways of utilizing and analyzing profile data to identify items that may be of interest to the identified user.

Certain embodiments of the location-based service modules 118 include a retailer communication engine 124. In certain embodiments, the retailer communication engine 124 is configured to query, for example, the inventory management system of the registered retailer to determine whether the registered retailer has the one or more items that have been identified as being of interest to the identified user. In certain embodiments, if the registered retailer has one or more items of interest available in stock, that information may be communicated to the mobile device as an alert (e.g., email, text, etc.). In certain embodiments, the user profile engine 122 is configured to determine whether discounts are available for the items of interest. As an example, the user profile engine may access product discount data 130 to determine whether there are any applicable sales/service items associated with the items of interest. In certain embodiments, the retailer communication engine 124 may communication with the registered retailer so that only items of interest having corresponding discounts are queried for availability at the registered retailer. In certain embodiments, the registered retailer may be queried for the availability of all items of interest. However, in certain embodiments, the mobile device communication engine may be configured to limit transmissions of alerts to the mobile device so that the user is only alerted to items of interest having corresponding product discounts and/or promotions. In this latter instance, inundation of the user of the mobile device with potentially irrelevant information is reduced. When irrelevant information is reduced, the user is more likely to pay attention to communications received at the mobile device than when the user is spammed with communications.

In certain embodiments, there may be a coupon or other redeemable identifier associated with a discounted item of interest. As such, certain embodiments of the mobile device communication engine 126 may transmit information relating to the coupon/redeemable identifier to a mobile device for display on a screen of the mobile device. In such instances, the user may present the coupon/redeemable identifier at the point-of-sale of the registered retailer to avail themselves of the discount and/or promotion.

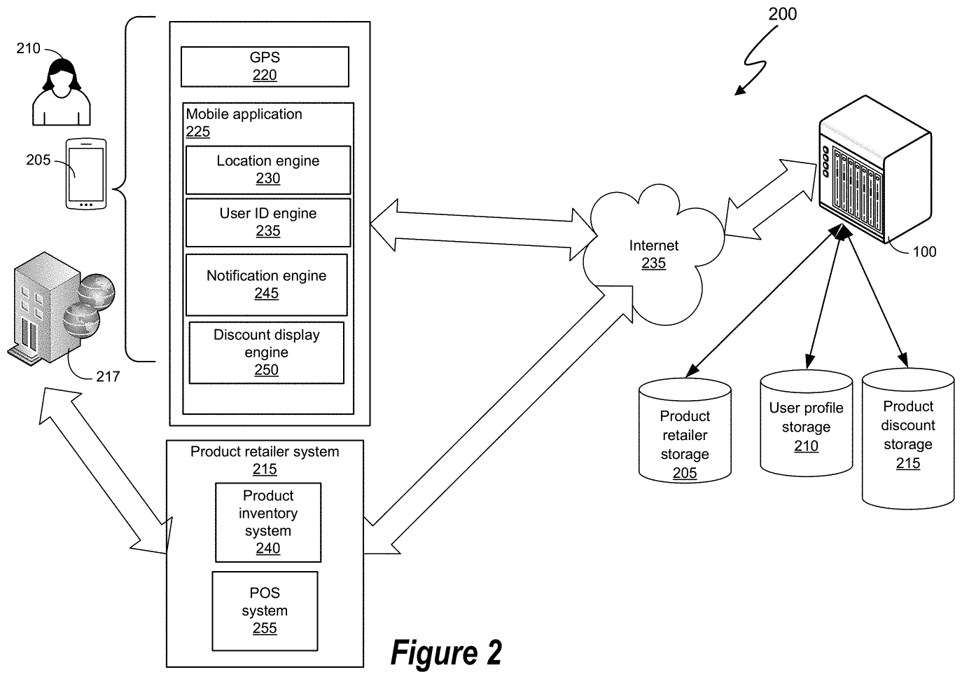

FIG. 2 is a block diagram of an electronic environment 200 in which certain embodiments of the location-based service system 100 may operate. In this example, the electronic environment 200 includes the location-based service system 100, a mobile device 205 operated by a user 210, and a product retailer system 215, which may or may not be located at a particular retail location 217. In certain embodiments, the location-based service system 100 is configured for handling items provided by a single supplier. In other embodiments, location-based service system 100 is configured for handling the products provided by multiple suppliers.

In certain embodiments, the electronic environment 200 includes registered retailer storage 205 that is accessible to the location-based service system 100. In certain embodiments, the registered retailer storage 205 includes information as to one or more of the retail locations of the product retailers, items authorized to be sold by the product retailers, product retailer websites, IP addresses or any other information that may be used to communicate with product retail systems.

In certain embodiments, the electronic environment 200 includes user profile storage 210 that is accessible to the location-based service system 100. As disclosed herein, the user profile storage 210 may include user profile information that is utilized to identify specific items that may be of interest to the user 210. In the example shown in FIG. 2, the location-based service system 100 has access to user profile data for the user 210 as well as other users that may have interest in items provided by a supplier.

In certain embodiments, electronic environment 200 includes product discount storage data 215 that is accessible to the location-based service system 100. In certain embodiments, the product discount storage 215 includes information relating to discounts and promotions available for items provided by a supplier. In certain embodiments, the product discount storage 215 and/or registered retailer storage 205 includes information as to whether a retailer is registered to participate in a discount and/or promotion for an item provided by a supplier.

In certain embodiments, the mobile device 205 includes a GPS device 220 and a mobile application 225. In certain embodiments, the mobile application 225 includes a location engine 230 that receives geolocation data from the GPS device 220, which identifies the location of the mobile device 205. In certain embodiments, the location engine 230 transmits the location of the mobile device 205 over, for example, the Internet 235. In certain embodiments, the location engine 230 transmits geolocation coordinates of the mobile device 205. In certain embodiments, location engine 230 transmits retailer identification data (e.g., retail location name, retail location address, etc.) that may be used by the location-based service system 100 to identify the retail location 217. In certain embodiments, the location-based service system 100 may initiate calls to the location engine 230 for updates on the location of the mobile device 205. In certain embodiments, the location engine 230 may check-in with the location-based service system 100 to update the location of the mobile device 205 at specific times and/or intervals. In certain embodiments, the registered retail location 217 and location engine 230 may communicate with one another to trigger the sending of the location data to the location-based service system 100 when the mobile device 205 is proximate the retail location 217. Certain embodiments use the location information provided by the location engine 230 and compare the received location information with location data for retail locations of product retailers. In certain embodiments, location information for product retailers is accessible by the location-based service system 100 from product retail storage 205.

In certain embodiments, the mobile application 225 includes a user ID engine 235. In certain embodiments, the user ID engine 235 transmits information to the location-based service system 100 that identifies user 210. Certain embodiments of the location-based service system 100 employ the information communicated by user ID engine 235 to access the corresponding profile of the user 210 from user profile storage 210. As described herein, certain embodiments employ the user profile information to identify products that may be of interest to the user 210. In certain embodiments, items of interest may be subject to a product discount and/or promotion. To this end, certain embodiments of the location-based service system for 100 may access discount and/or promotional information for the items of interest from the product discount storage 215.

In certain embodiments, the location-based service system 100 queries the registered retailer system 215 when the location-based service system 100 receives information indicating that the mobile device 205 is proximate the retail location 217. In certain embodiments, the location-based service system 100 communicates with a product inventory system 240 of the registered retailer to determine whether any items of potential interest are currently stocked at the retail location 217. In certain embodiments, if the product retailer operates out of more than one retail location, the location-based service system 100 may communicate with the product inventory system 240 to determine whether the items of potential interest are available at the retail location 217.

In certain embodiments, if the product inventory system 240 indicates that any of the items of potential interest are available at the retail location 217, the location-based service system 100 may communicate this fact to the notification engine 245 of the mobile application 225. In certain embodiments, the location-based service system 100 only sends alerts to the notification engine 245 for items that are subject to a discount or promotion. In certain embodiments, the location-based service system 100 sends alerts to the notification engine 245 whenever any of the items of potential interest are in stock at the retail location 217, or otherwise available at a related retail location 217. The notification engine 245 may be implemented as part of the mobile application 225, external to the mobile application 225, and/or integrated with electronic communication services (e.g., email, text, etc.) within the mobile device 205.

In certain embodiments, the location-based service system 100 may determine that one or more of the items of interest are subject to a discount or promotional program. In certain embodiments, registered retailer may require the user 210 to present a coupon or other promotional identifier to the registered retailer in order to purchase an item of interest. Accordingly, certain embodiments of the location-based service system 100 may send a coupon or other promotional identifier to a discount display engine 250. In certain embodiments, the discount display engine 250 receives the coupon or other promotional identifier information for display on a display screen of the mobile device 205. In turn, the coupon or other promotional identifier displayed on the display screen may be presented at the point-of-sale 255 of the registered retailer system 215 for redemption.

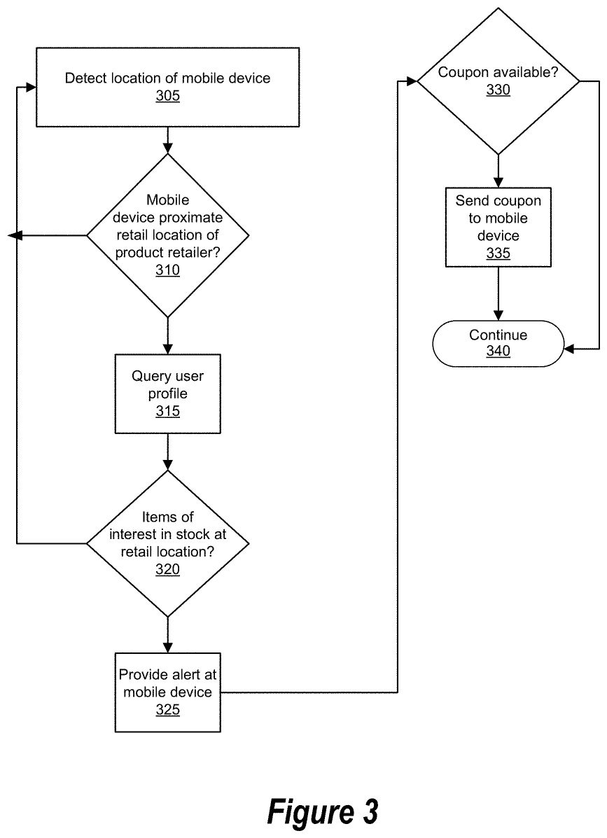

FIG. 3 is a flowchart depicting exemplary operations that may be executed by various components within the electronic environment 200. In certain embodiments, the location of the mobile device is detected at operation 305. As described herein, the location of the mobile device may be detected and communicated within the environment 200 in various manners. As an example, the location of the mobile device may be transmitted to the location-based service system 100 using geolocation data. As a further example, location of the mobile device may be stored as part of the mobile application and provided to the location-based service system 100 using retail location data such as, for example, retailer name, retailer address, retailer phone number, etc.

There are various manners that may be used to trigger transmission of the location of the mobile device to a location-based service system 100. In some examples, the mobile device transmits its location data at scheduled times, at scheduled intervals, etc. In some examples, the mobile device may include a database associated with known retail locations. In such examples, the mobile device may transmit its location information when the location indicated by the GPS system 220 is within a predetermined distance of the retail location 217. In some examples, the retail location 217 may implement a Wi-Fi network, a Bluetooth network, etc. to communicate directly with the mobile application. for proximity detection. As an example, a wireless system at that the retail location 217 may transmit information to the mobile application that triggers transmission of the mobile device location 205 from, for example, the mobile device. In certain embodiments, the wireless system at the retail location 217 may itself transmit an indication to the location-based service system 100 that the mobile device is proximate the retail location 217.

At operation 310, certain embodiments determine whether the mobile device is proximate the retail location 217. If the mobile device as not proximate the retail location 217, detection of the location of the mobile device may continue at operation 305 until such time as a mobile device is proximate a retail location of a product retailer. However, if the mobile device is indeed proximate a retail location of a product retailer, information related to the user ID (e.g., identification information sent by the mobile device, etc.) may be used to query a user profile to determine whether there are items of potential interest to the user that may be sold by the registered retailer. If the query at operation 315 identifies items of interest, a determination is made at operation 320 as to whether the items of interest are in stock or otherwise timely available at the product retail location. If items of interest are not available, the flow of operations may proceed to operation 305 to continue detection of the location of the mobile device until such time as the mobile device is proximate a retail location of a product retailer. Otherwise, an alert may be provided on the mobile device at operation 325 to inform the user of the availability of the item of interest at the retail location. As described herein, the alert may be provided as an email, text, etc. In certain embodiments, the mobile application may present alerts on the display of the mobile device using custom format.

In certain embodiments, the item of interest may be a subject of a promotional and/or discount program requiring presentation of a coupon or other promotional identifier. As such, certain embodiments determine whether such a coupon or other promotional identifier is available at operation 330. If available, the coupon or other promotional identifier is sent to the mobile device at operation 335. In certain embodiments, the coupon or other promotional identifier may be provided on a display of the mobile device and presented to the registered retailer for redemption. In certain embodiments, if a coupon is unavailable or the coupon has arty been sent to the mobile device, the flow of operations may continue at operation 340. It will be recognized that the continuity of operations at operation 340 may include any other operations used in conducting a transaction, such as purchase of an item, and/or a return to operation 305 to continue detection of the location of the mobile device for proximity to another retail location.

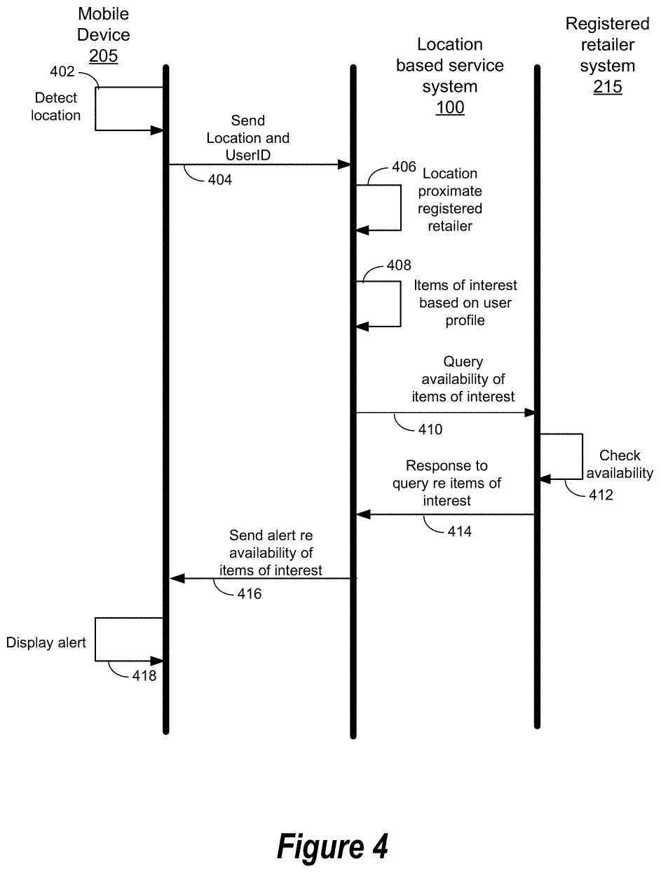

FIG. 4 is a diagram depicting the flow of communication and operations that may be executed in certain embodiments. As shown in this example, the mobile device 205 may detect its location at operation 402 and sends its location data at operation 404. In certain embodiments, the location data may include user identification information associated with a user of the mobile device 205. At the location-based service system 100, a determination is made at operation 406 as to whether the location received from a mobile device is proximate a retail location of a product retailer At operation 408, certain embodiments utilize the UserID information to access the user profile and determine whether there are any items of that may be of interest to the user. In certain embodiments, the determination at operation 408 may be limited to only those items that the product retailer is authorized to sell and/or service. At operation 410, certain embodiments of the location-based service system 100 send a query to a product retailer system 215 associated with the retail location to determine whether the items of interest are available. In certain embodiments, availability may be based on whether the item of interest is in stock at a retail location, can be timely shipped to or from the retail location, etc. In certain embodiments, the product retailer system 215 checks the availability of the item of interest at operation 412 and responds to the query at operation 414. If the item of interest is available at the retail location, the location-based service system 100 may send an alert regarding the availability of the item at operation 416. In certain embodiments, an alert regarding the availability of the item of interest is displayed at the mobile device 205 to the user at operation 418.

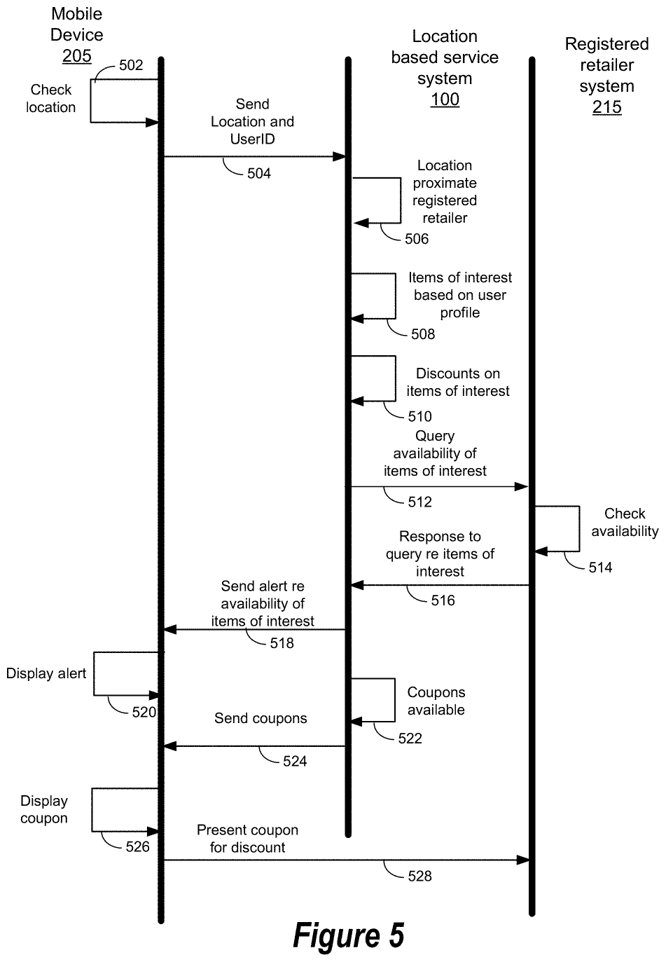

FIG. 5 is a diagram depicting the flow of communication and operations that may be executed in certain embodiments. As shown in this example, the mobile device 205 may detect its location at operation 502 and sends its location data at operation 504. In certain embodiments, the location data may include user identification information associated with a user of the mobile device 205. At the location-based service system 100, a determination is made at operation 506 as to whether the location received from a mobile device is proximate a retail location of a product retailer. At operation 508, certain embodiments utilize the UserID information to access the user profile and determine whether there are any items of that may be of interest to the user. In certain embodiments, the location-based service system 100 determines whether there are discounts or promotions available for the items of interest at operation 510. A query as to the availability of items of interest may be sent at operation 512. In certain embodiments, the query may be limited to only those items that the registered retailer is authorized to sell and/or service. At operation 510, certain embodiments of the location-based service system 100 send a query to the registered retailer system 215 to determine whether the items of interest are available. In certain embodiments, the query at operation 512 is only sent if a determination is made at operation 510 that there are discounts or other promotions available for the items of interest. In certain embodiments, the registered retailer system 215 checks the availability of the item of interest at operation 514 and responds to the query at operation 516. If the item of interest is available at the retail location, the location-based service system 100 may send an alert regarding the availability of the item at operation 518. In certain embodiments, an alert regarding the availability of the item of interest is displayed at the mobile device 205 to the user at operation 524. In certain embodiments, the location-based service system 100 determines at operation 522 whether there are coupons or other redemption identifiers that may be used to take advantage of the availability of the item of interest at the retail location. If a coupon or other redemption identifier is available, the location-based service system 100 may send the coupon or redemption identifier to the mobile device 205 at operation 524 and the coupon or redemption identifier is displayed on a display of the mobile device 205 at operation 526 for redemption by the user at a point-of-sale system of the product retailer system at operation 528.

It will be recognized, in view of the teachings of the present disclosure, that variations on the sequence of operations shown in FIG. 4 and FIG. 5 may be made without departing from the basic operation of the overall system. As an example, the location-based service system 100 may determine whether there are coupons or other redemption identifiers associated with an item of interest for sending the alert regarding the availability of the items of interest. In such instances, the location-based service system may send any alert and coupons/redemption identifiers concurrently to the mobile device. In certain embodiments, the location-based service system may prioritize the items of potential interest to the user and only continue operation with respect to items having the highest priority. Other variations on such operations may also be implemented based on the teachings of the present disclosure.

As will be appreciated by one skilled in the art, the system disclosed herein may be embodied as a method, system, or computer program product. Accordingly, embodiments of the disclosed system may be implemented in hardware, in software (including firmware, resident software, micro-code, etc.) or in an embodiment combining software and hardware. Furthermore, the disclosed system may take the form of a computer program product on a computer-usable storage medium having computer-usable program code embodied in the medium.

Any suitable computer-usable or computer-readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the disclosed system may be written in an object oriented programming language such as Java, Smalltalk, C++ or the like. However, the computer program code for carrying out operations of the disclosed system may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the disclosed system are described with reference to flowchart illustrations and/or block diagrams of methods, apparatus (systems) and computer program products according to embodiments of the disclosed system. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The disclosed system is well adapted to attain the advantages mentioned as well as others inherent therein. While the disclosed system has been depicted, described, and is defined by reference to particular embodiments of the disclosed system, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implemented method for personalized proximity marketing comprising:
detecting whether a mobile device is proximate a retail location of a product retailer;
if the mobile device is proximate a retail location of the product retailer, querying a user profile associated with a user of the mobile device to determine whether the retail location has one or more items of interest available to the user of the mobile device, wherein the one or more items of interest are identified based on product preferences associated with the user profile; and
in response to the query, alerting a user at the mobile device one or more of the items of interest are available at the retail location.

2. The computer-implemented method of claim 1, further comprising:
notifying the user at the mobile device that one or more items of interest are subject to a discount at the retail location.

3. The computer-implemented method of claim 2, further comprising:
receiving a coupon that is displayable at the mobile device, wherein the coupon is redeemable for a discount on the one or more items of interest at the retail location.

4. The computer-implemented method of claim 1, wherein detecting whether a mobile device is proximate a retail location of a product retailer comprises:
transmitting a location of the mobile device to a location-based service system;
comparing, at the location-based service system, the location of the mobile device and product retailer locations to determine whether the user device is proximate a retail location; and
receiving, at the location-based service system, user identification information from the mobile device, wherein the location-based service system identifies one or more items of interest based on the user profile associated with the user identification information.

5. The computer-implemented method of claim 4, further comprising:
querying, by the location-based service system, a product inventory system associated with the retail location to determine whether the one or more items of interest are available at the retail location.

6. The computer-implemented method of claim 5, further comprising:
determining, by the location-based service system, whether one or more of the items of interest are subject to a discount available at the retail location.

7. The computer-implemented method of claim 6, further comprising:
transmitting, by the location-based service system, an alert to the mobile device that one or more of the items of interest are available at the retail location and subject to the discount; and
transmitting, by the location-based service system, information to the mobile device that may be translated to a coupon or other redeemable identifier displayable at a display of the mobile device, wherein the displayable coupon or other redeemable identifier is redeemable at the retail location.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
detecting whether a mobile device is proximate a retail location of a product retailer;
if the mobile device is proximate a retail location of the product retailer, querying a user profile associated with a user of the mobile device to determine whether the retail location has one or more items of interest available to the user of the mobile device, wherein the one or more items of interest are identified based on product preferences associated with the user profile; and
in response to the query, alerting a user at the mobile device that one or more of the items of interest are available at the retail location.

9. The system of claim 8, wherein the instructions are further configured for:
notifying the user at the mobile device that one or more of the items of interest are subject to a discount at the retail location.

10. The system of claim 9, wherein the instructions are further configured for:
receiving a coupon that is displayable at the mobile device, wherein the coupon is redeemable for a discount on one or more of the items of interest at the retail location.

11. The system of claim 8, wherein detecting whether a mobile device is proximate a product retailer includes instructions configured for:
transmitting a location of the mobile device to a location-based service system;
comparing, at the location-based service system, the location of the mobile device and the product retailer to determine whether the user device is proximate the retail location; and
receiving, at the location-based service system, user identification information from the mobile device, wherein the location-based service system identifies one or more items of interest based on the user profile associated with the user identification information.

12. The system of claim 11, wherein the instructions are further configured for:
querying, by the location-based service system, a product inventory system associated with the retail location to determine whether the one or more items of interest are available at the retail location.

13. The system of claim 12, wherein the instructions are further configured for:
determining, by the location-based service system, whether a discount on one or more of the items of interest available at the retail location is subject to a discount available at the retail location.

14. The system of claim 13, wherein the instructions are further configured for:
transmitting, by the location-based service system, an alert to the mobile device that one or more of the items of interest are available at the retail location and subject to the discount; and
transmitting, by the location-based service system, information to the mobile device that may be translated to a coupon displayable at a display of the mobile device, wherein the displayable coupon is redeemable at the retail location.

15. A non-transitory, computer-readable storage medium embodying computer program code, the computer program code comprising computer executable instructions configured for:
detecting whether a mobile device is proximate a retail location of a product retailer;
if the mobile device is proximate a retail location of the product retailer, querying a user profile associated with a user of the mobile device to determine whether the retail location has one or more items of interest available to the user of the mobile device, wherein the one or more items of interest are identified based on product preferences associated with the user profile; and
in response to the query, alerting a user at the mobile device that one or more items of interest are available at the retail location.

16. The non-transitory, computer-readable storage medium of claim 15, wherein the instructions are further configured for:
notifying the user at the mobile device that one or more of the items of interest are subject to a discount at the retail location.

17. The non-transitory, computer-readable storage medium of claim 16, wherein the instructions are further configured for:
receiving a coupon that is displayable at the mobile device, wherein the coupon is redeemable for a discount on one or more of the items of interest at the retail location.

18. The non-transitory, computer-readable storage medium of claim 15, wherein detecting whether a mobile device is proximate a product retailer includes instructions further configured for:
transmitting a location of the mobile device to a location-based service system;
comparing, at the location-based service system, the location of the mobile device and retail locations of the product retailer to determine whether the user device is proximate a retail location; and
receiving, at the location-based service system, user identification information from the mobile device when the mobile device is proximate a retail location of the product retailer, wherein the location-based service system identifies one or more items of interest based on the user profile associated with the user identification information.

19. The non-transitory, computer-readable storage medium of claim 18, wherein the instructions are further configured for:
querying, by the location-based service system, a product inventory system associated with the retail location to determine whether the one or more items of interest are available at the retail location.

20. The non-transitory, computer-readable storage medium of claim 19, wherein the instructions are further configured for:
determining, by the location-based service system, whether a discount on one or more of the items of interest available at the retail location are subject to a discount available at the retail location; and
transmitting, by the location-based service system, an alert to the mobile device that one or more of the items of interest are available at the retail location and subject to the discount; and
transmitting, by the location-based service system, information to the mobile device that may be translated to a coupon or other redeemable information displayable at a display of the mobile device, wherein the displayable coupon or other redeemable information is redeemable at the retail location.
